(19) United States
(12) Patent Application Publication
(10) Pub. No.: US 2007/0152102 A1
(43) Pub. Date: Jul. 5, 2007

(54) High drag parachute with radial slots providing porosity distribution and enhanced stability without forward speed

(76) Inventors: William L. B. Gargano, Boulder, CO (US); Robert Sinclair, Costa Mesa, CA (US); Anthony P. Taylor, Huntington Beach, CA (US)

Correspondence Address: JACOBSON HOLMAN PLLC, 400 SEVENTH STREET N.W., SUITE 600, WASHINGTON, DC, 20004, US

(21) Appl. No.: 11/324,241

(22) Filed: Jan. 4, 2006

(51) Int. Cl. B64D 17/02

(52) U.S. Cl. 244/145

(57) ABSTRACT

A parachute having radial slots distributed at regular intervals around the shoulder region to effect boundary flow separation, causing Von Karmen Vortex Street shed vortices to separate in a symmetrical manner from the inflated shape and resulting in an extremely stable aerodynamic decelerator. In addition, pressure vents in the crown region vent high pressure air during the inflation process to contribute to opening load control. Once the parachute is fully inflated, the pressure vents provide energetic airflow that ensures that the shed vortices created by the radial slots do not re-contact the canopy and cause instability.

### BACKGROUND OF THE INVENTION

1. Field of the Invention

The present invention relates generally to round canopy parachutes and, more particularly, to a ring slot parachute having radial slots.

2. Description of the Related Art

The use of sails in parachutes is an established technique that is well documented in the ring sail and hybrid classes of parachutes. In the hybrid designs, generally a single row of sails in the shoulder region of the parachute is used to provide a fixed location for flow separation. This fixed location, combined with other features, is often critical to creating a parachute that has good stability while retaining a high drag coefficient.

Sails have a down side, however, in that they are difficult to pack and thus become impractical in applications with significant packing requirements such as mass parachute assault.

In addition, high drag canopies tend to either glide or be unstable. Previous efforts to improve stability have included employing slots that are continuous around the entire canopy but this method can cause drag loss and inflation stall. Further, many slotted designs such as those disclosed in U.S. Pat. Nos. 3,298,639 and 3,809,342, are designed to provide forward/horizontal velocity through the incorporation of panels that create “jets” of air. However, forward motion is not desirable in many deployment scenarios and can be dangerous, such as in mass parachute assault, particularly at night, when multiple personnel and/or cargo payloads might easily collide with one another.

An alternative slot design having what are known as “cat eye” slots is disclosed in U.S. Pat. No. 2,734,706. The cat eye slots, have loose fabric which, upon loading, effectively closes the slots. Hence, radial venting is not constant.

Therefore, a need exists for a parachute design that is able to provide constant defined flow separation locations comparable to that obtained with sails, while being easier to pack and manufacture, and at the same time provide enhanced stability and high drag without forward speed.

### SUMMARY OF THE INVENTION

In accordance with these and other objects, the present invention is directed to a parachute having radial slots distributed at regular intervals around the shoulder region of the parachute and having pressure vents in the crown region. The radial slots provide a mechanism to effect boundary flow separation at the shoulder region, causing Von Karmen Vortex Street (VKVS) shed vortices to separate in a symmetrical manner from the inflated shape. This symmetrical separation of the VKVS shed vortices results in an extremely stable aerodynamic decelerator (parachute).

The pressure vents in the crown region contribute to opening load control by venting high-pressure air through the crown during the inflation process. Once the parachute is fully inflated, these vents provide energetic airflow that ensures that the shed vortices created by the radial slots do not re-contact the canopy and cause instability.

Accordingly, it is an object of the present invention to provide a high stability, high drag parachute with improved opening load management.

Another object of the present invention is to provide a parachute that demonstrates high stability without forward speed.

A further object of the present invention is to provide a parachute with radial slots designed to provide constant radial venting.

Yet another object of the present invention is to provide a radially slotted parachute with pressure vents in the crown region for venting high-pressure air during the inflation process.

A still further object of the present invention is to provide a parachute having radial slots and pressure vents that remain open once the chute is fully inflated, the pressure vents providing energetic flow to ensure that the VKVS shed vortices created by the radial slots do not re-contact the canopy and cause instability.

Still another object of the present invention is to provide a parachute having radial slots that can be fully open or covered with mesh material, the size of the slot openings being designed to match a desired balance between oscillation and rate of descent.

A still further object of the present invention is to provide a parachute having radial slots covered with mesh material in which the pattern for the mesh material is shaped to correspond with the radial opening when inflated.

Yet a further object of the present invention is to provide a parachute that is easier to manufacture and pack than conventional ring sail parachutes while providing good stability and a high drag coefficient.

These together with other objects and advantages which will become subsequently apparent reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 shows a side view of an inflated parachute (with only the top portion of the suspension lines shown) having radial slots and pressure vents in accordance with the present invention.

FIG. 2 illustrates a gore portion of a parachute canopy having radial slots that follow the cloth weave.

FIG. 3 illustrates a gore portion of a parachute canopy having radial slots that are parallel to the radial.

FIG. 4 is a top view of a parachute canopy as laid flat and having mid-gore radial slots of the cloth weave type as shown in FIG. 2.

FIG. 4A depicts a single gore from the parachute canopy of FIG. 4.

FIG. 5 is a top view of a parachute canopy as laid flat and having multiple radial slots of the parallel radial type as shown in FIG. 3.

FIG. 5A depicts a single gore from the parachute canopy of FIG. 5.

FIG. 6 is a top view of a parachute canopy as laid flat and having long radial slots of the parallel radial type as shown in FIG. 3.

FIG. 6A depicts a single gore from the parachute canopy of FIG. 6.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

As shown in FIG. 1, the present invention is directed to a parachute generally designated by the reference numeral 10. The parachute 10 includes a canopy 12 constructed from a plurality of gores, generally designated by the reference numeral 14, that meet together at the peak vent 16 of the canopy and extend to the lower edge 18 thereof. Suspension lines 20 are secured to the lower edge 18 in a manner known in the art. The canopy fabric can have a range of porosities. For example, a cloth enabling an airflow of about 0-3 cubic feet per minute (CFM) may be appropriate in some applications while a different cloth having a much greater porosity, on the order of 30-50 CFM for example, may be used in other applications.

The gores 14 include a plurality of panels 22 that are stitched or otherwise connected to one another along their circumferential seams 21 as well as along their radially extending edges or radials 24. Radial slots 26 are formed in the slotted gore panels 22a, positioned adjacent the radials 24, and spaced around the shoulder region, generally designated by the reference numeral 28, of the canopy 12. According to the embodiment shown in FIG. 1, the basic canopy has been shaped with an extended skirt, as is known in the art, such that the shoulder region 28 has a greater diameter than the lower edge 18.

Each gore 14 has two slots 26a, 26b that are aligned with one another circumferentially so as to, together with the slots of adjacent gores, form a slot ring 30. However, any number of slots, including none, may be included in any particular gore. Thus, the slots may be placed on every gore or on only some of the gores and in any pattern, such as only on alternating gores, on every third gore, etc.

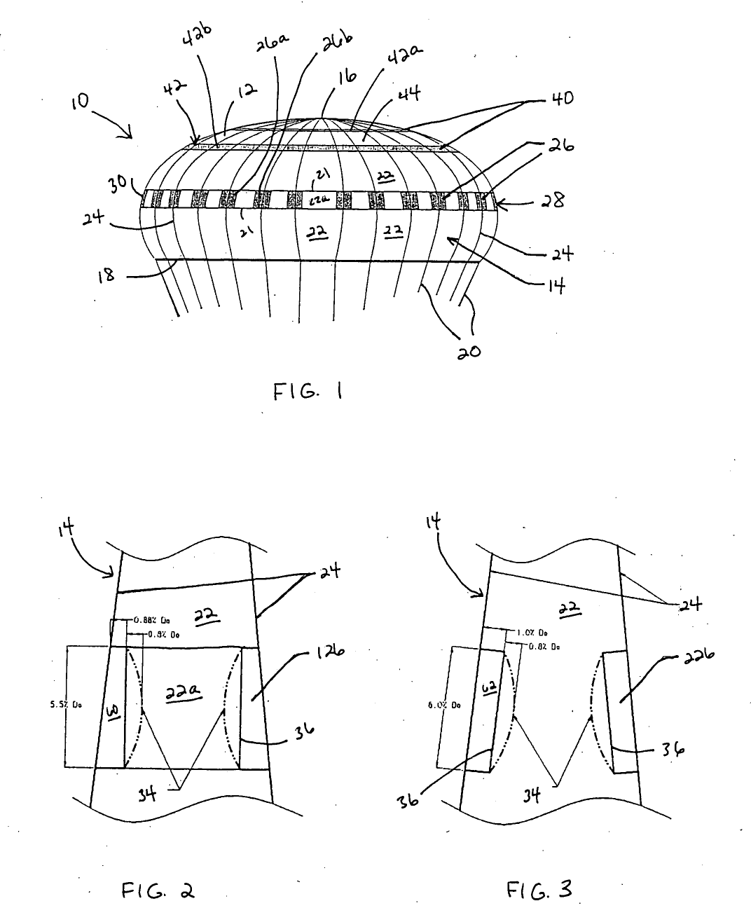

The radial. slots 26 may be constructed to follow the cloth weave of the panels, as shown by the cloth weave slots 126 in FIG. 2, or to be parallel with the radials 24 as shown by the parallel radial slots 226 depicted in FIG. 3. As referenced herein, slot 26 is used generally to refer to either the cloth weave slots or the parallal radial slots when either could be used. In addition, slots of other shapes could also be used and are intended to be included within the general designator of reference numeral 26.

When made to follow the cloth weave, the slots 126 have a truncated rectangular or trapezoidal shape that, compared with the consistent width of the parallel radial slots 226 which are rectangular, extend further into the panel 22 of the gore 14. Because of this deeper extension and the resulting increase in slot size, the cloth weave radial slots 126 allow for a greater airflow and thus faster descent. The parallel radial slots 226, by contrast, have a slower rate of descent, and hence a better drag coefficient, than the cloth weave slots.

When constructing a parachute 10 according to the present invention, design decisions relating to the inclusion of cloth weave slots versus parallel radial slots depend upon the aerodynamic performance requirements of the canopy. Optimally, the slots 26 are sized, shaped and positioned to ensure that symmetrical vortex shedding is achieved at a magnitude sufficient to achieve the desired stability for each specific canopy shape, e.g., flat, conical, polyconical, hemi-spherical, extended skirt, etc.

The slots 26 can be entirely open areas, defining a gap such that air flow through the slots is unimpeded. Alternatively, the slots can be covered or partially covered with a partially occluding material 32 such as mesh that continues to allow air flow but which also reduces the risk of entanglement in the event that another jumper were to collide with the canopy, i.e., the partially occluding material prevents the other jumper from “putting his boot through the hole” and endangering both himself and the jumper whose canopy has been entangled.

According to one preferred embodiment, the partially occluding material is a mesh cloth 32, but any type or combination of mesh, tapes, cloth with holes or with partially covered holes or openings, may be used. For ease of description, the partially occluding material used to cover the slots will be referred to herein as “mesh”, but with the understanding that this term includes other materials that are able to provide the same or comparable function.

In addition to protecting against jumper entanglement, the mesh also serves to control the geometry of the slot, ensuring that the slot does not change shape as a function of dynamic pressure. This shape-retaining function is best achieved when the pattern shape 34 of the mesh 32 is adjusted to correspond with the inflated shape of the slots. As shown in FIGS. 2 and 3, when inflated, the slots 26 demonstrate a curvature along their edges 36 which is created by the upward force of air against the underside of the canopy, creating a “bulge” in the fabric adjacent the slot edge 36. To utilize this shape, the mesh 32 is not cut precisely to match the truncated rectangular shape of the slot 126 shown in FIG. 2 or the rectangular shape of the slot 226 shown in FIG. 3. Instead, the mesh is sized to include additional material so as to allow the slot edges 36 to bulge or expand to an extent and shape generally corresponding to that created by inflated slot edges in the absence of a mesh covering.

Because the mesh partially occludes the slot opening, some attenuation of the air flow through the slot does occur, degrading the performance of the slot in terms of flow. However, this can be effectively compensated through an appropriate increase in the size of the slots when designing a canopy to have mesh-covered slots.

In addition to the slots, the gores of the canopy according to the present invention are further provided with one or more pressure vents 40 positioned between the peak vent 16 of the chute and the shoulder region 28. Like the slots 26, the vents 40 in adjacent gores are aligned circumferentially so that together they form a pressure vent ring, generally designated by the reference numeral 42.

The pressure vents 40 serve two primary purposes. First, they provide for an outflow of air that re-energizes the boundary flow from the slots 26. The outflow precludes the airflow that is initially attached to the canopy from the skirt at the lower edge 18 to the base of the slots, from re-attaching to the upper surface 44 of the canopy. This serves to maintain the stability of the parachute by eliminating asymmetric vortex shedding. Second, during the inflation process, the control of air outflow afforded by the vents 40 enables the parachute designer to tailor the size of the slots 26 to accomplish desired load management. More particularly, the position and width of the vents 40 controls the early shape formation during inflation and ensures that early drag growth is arrested at the most suitable point to realize acceptable parachute opening loads.

As shown in FIG. 1, when multiple pressure vent rings 42a, 42b are included, they are spaced from one another and may be of different widths. The size and position of the ring or rings is selected based on the performance requirements and airflow characteristics of the canopy.

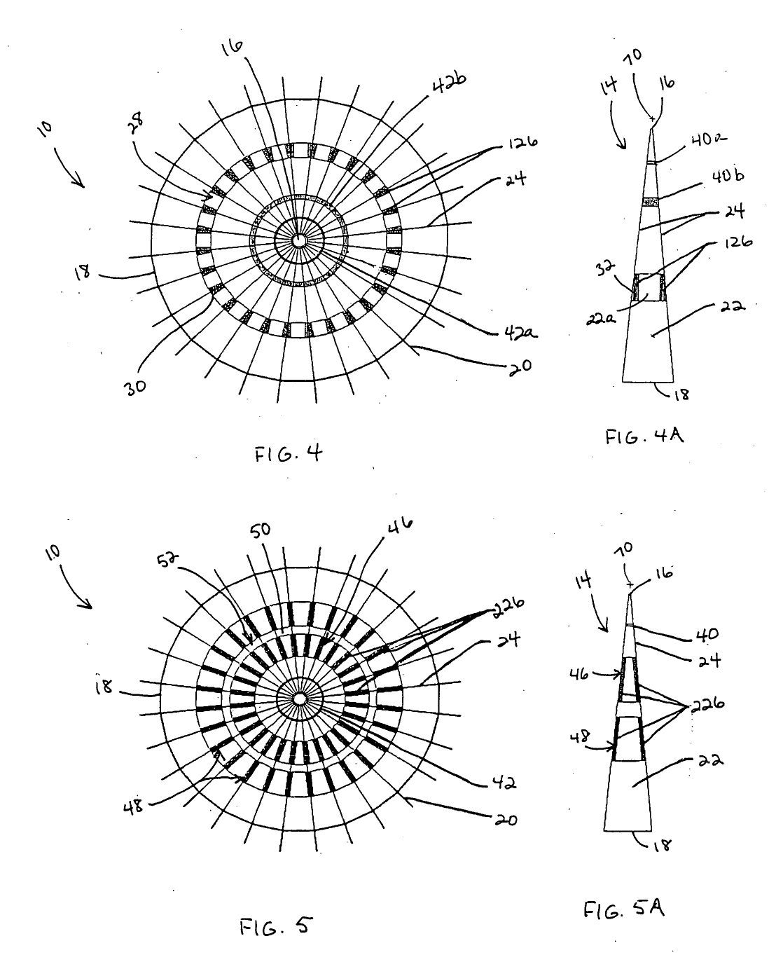

The arrangement and number of the slots 26 and pressure vents 40 may be varied according to various designs. In the embodiment shown in FIGS. 4 and 4A, each gore has a pair of cloth weave radial slots 126 positioned generally midway along the panels in the shoulder region 28 of the canopy. Above the shoulder region 20 28 in each gore are two pressure vents 40a, 40b of different widths and spaced from one another according to the design requirements.

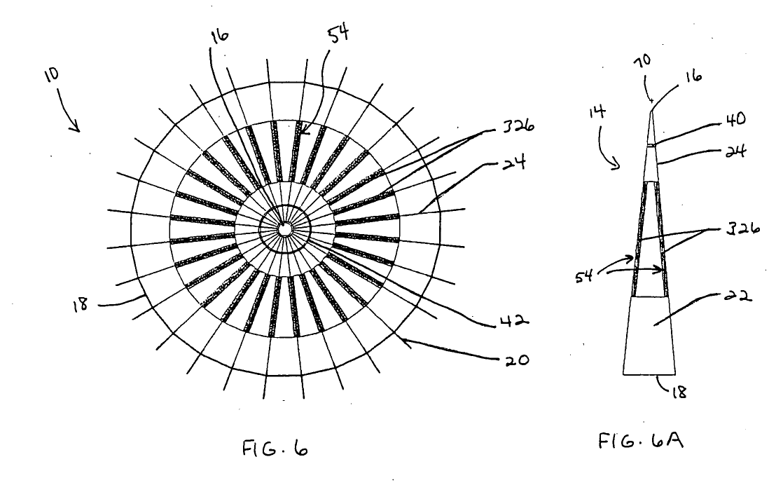

An alternative embodiment having multiple radial slots 26 and a single pressure vent ring 42 is shown in FIGS. 5 and 5A. Each gore has an upper set of radial slots, generally designated by the reference numeral 46, and a lower set of radial slots, generally designated by the reference numeral 48, with the “upper” and “lower” designations being relative to the peak of the canopy. The sets of slots 46, 48 are radially spaced from one another by a mid-gore panel 50. When the gores are attached to one another along their radials 24 in the constructed canopy 12, the slots 226 as arranged around the canopy form two concentric rings 30a, 30b, separated by an intervening cloth ring, generally designated by the reference numeral 52, formed by the adjoining mid-gore panels 50.

While both sets of slots 46, 48 shown in FIGS. 5 and 5A are of the parallel radial type 226, the sets may be advantageously of different types. For example, parallel radial slots 226 may be used for the upper set 46 nearest the peak 16 to maximize drag while cloth weave slots 126 are arranged in the lower set 48 to improve vortex shedding. By tailoring slot type to canopy position in this way, the performance benefit obtained from each type can be maximized.

A further alternative is illustrated in FIGS. 6 and 6A in which a single set, generally designated by the reference numeral 54, of long radial slots 326 and a single pressure vent ring 42 are provided. When using long slots 326 such as those shown, parallel radial slots 226 with their better drag coefficient are generally preferable to cloth weave slots.

While cloth weave slots and parallel radial slots have been specifically set forth in the disclosed embodiments, the slots according to the present invention are intended to include slots of any width, height or shape along or within about eight inches of the radial, and in any position along the radial. With particular reference to the cloth weave slots, further variability in shape may be introduced by changing the orientation or weave direction of the cloth in the slotted panels 22a. By adjusting the weave direction in these panels 22a, the width of the base of the trapezoidal cloth weave slot can be increased or decreased relative to the width of the parallel side.

As an example, in the preferred embodiments shown in FIGS. 2 and 4A, the cloth weave of panels 22 as well as slotted panel 22a is oriented such that for all the panels in the canopy the cloth warp and weft are respectively perpendicular and parallel to the lower edge 18 of the gore. This is known as a block construction. To vary the shape of the slots while retaining the block construction baseline performance, the weave direction in the slotted panel 22a is angled so that the warp and weft are no longer perpendicular and parallel, respectively, to the gore lower edge 18; the block construction is retained in the remainder of the canopy panels 22.

The size of the slot openings can range from only a slit in the cloth to an excised portion taken from the cloth having a selected shape such as the truncated rectangular (trapezoidal) area 60, or the generally rectangular area 62, shown in FIGS. 2 and 3, respectively. These areas 60, 62 can have a width up to one third the width of the gore and can be on both sides thereof as shown, leaving the center one third of the gore (or more) cloth. This range of slot sizes is applicable to both open slots and mesh-covered slots.

The positioning of the radial slots relative to the pressure vents is dependent upon the type and number of slots, and the desired performance characteristics of the canopy. According to one preferred embodiment shown in FIGS. 4 and 4A, the radial slots 126 are positioned so as to be down approximately 64% of the radius of the canopy from the vent center 70, where the vent center 70 represents the point at which all the vent lines cross. Vent lines (not shown) span the opening in the peak vent 16 of the parachute and attach to opposite radials at the top of each gore where the fabric ends, as is well known in the art.

The relationship of the total area of the slots to the reference diameter of the canopy, Do, varies according to slot style. Assuming the “canopy reference area” is the area of a single gore, including the slots and vents, multiplied by the number of gores, the reference diameter is the diameter of a circle determined from this reference area. By calculating the area of all of the slots and assuming this area to be the area of a second circle, this second circle corresponds with the percentage diameters shown in FIGS. 2 and 3. Therefore, the cloth weave slots shown in FIG. 2 have an area of approximately 5.5% of the reference diameter, Do, of the canopy. The parallel radial slots of FIG. 3, on the other hand, have an area of approximately 6.0% of the reference diameter.

As just described, the radial slots provide constant radial venting while the pressure vents provide energetic flow to ensure that the VKVS shed vortices created by the radial slots do not re-contact the canopy and cause instability. Furthermore, the parachute according to the present invention does not have a forward speed component, making it suitable for a variety of deployment scenarios requiring precise drop zones. This absence of forward speed is achieved by symmetric placement of the radial slots.

The parachute according to the present invention may be used for both personnel and payload deployment. For personnel, the preferred size range of the diameter of the canopy is between about 25-45 feet. For cargo applications, the canopy size can be much larger or smaller depending upon the cargo and the parachute performance requirements. The ratio between payload weight and the canopy size is also adjustable according to specific application requirements.

The foregoing descriptions and drawings should be considered as illustrative only of the principles of the invention. The invention may be configured in a variety of shapes and sizes and is not limited by the dimensions of the preferred embodiment. Numerous applications of the present invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

What is claimed is:

1. A parachute canopy comprising a plurality of gores connected to one another along radial edges extending from a peak of said canopy to a lower edge thereof, at least some of said gores including at least one slot formed along at least one radial in a shoulder portion of said canopy such that the slots are equally spaced circumferentially in a ring around said shoulder portion.

2. The parachute canopy as set forth in claim 1, wherein each gore has a pair of radial slots, one on each respective radial edge, said slots aligned with one another as part of said slot ring.

3. The parachute canopy as set forth in claim 2, wherein said radial slots follow a cloth weave of said gore so as to have a truncated rectangular shape.

4. The parachute canopy as set forth in claim 2, wherein said radial slots are parallel to said radials so as to have a rectangular shape.

5. The parachute canopy as set forth in claim 2, wherein each gore includes a second pair of radial slots circumferentially aligned with one another and positioned between said shoulder portion slot ring and said peak so as to form a second radial slot ring spaced from and concentric with said shoulder portion slot ring.

6. The parachute canopy as set forth in claim 5, wherein the slots in said shoulder portion slot ring follow a cloth weave of said gore so as to have a truncated rectangular shape.

7. The parachute canopy as set forth in claim 6, wherein the slots in said second radial slot ring are parallel to said radials so as to have a rectangular shape.

8. The parachute canopy as set forth in claim 1, wherein said slots are covered with a mesh panel.

9. The parachute canopy as set forth in claim 8, wherein said mesh panel is shaped to correspond to a non-mesh-covered inflated radial slot shapes.

10. The parachute canopy as set forth in claim 2, wherein each gore includes a pressure vent between the respective gore slot and the peak, the pressure vents together forming a pressure vent ring concentric with said slot ring.

11. The parachute canopy as set forth in claim 10, wherein each gore includes an additional pressure vent positioned between said pressure vent ring and said peak, said additional pressure vents in adjacent relationship forming an additional pressure vent ring concentric with said pressure vent ring.

12. The parachute canopy as set forth in claim 2, wherein each slot has a width approximately one third of a width of the respective gore within which the slot is formed.

13. The parachute canopy as set forth in claim 1, wherein said slots are formed on alternating gores.

14. A parachute canopy comprising a plurality of gores connected to one another along radial edges extending from a peak of said canopy to a lower edge thereof, at least some of said gores including at least one slot formed along at least one radial in a shoulder portion of said canopy such that the slots are equally spaced circumferentially in a ring around said shoulder portion, each of said slotted gores further including a pressure vent between the respective gore slot and the peak, the pressure vents together forming a pressure vent ring concentric with said slot ring.

15. The parachute canopy as set forth in claim 14, wherein each gore has a pair of radial slots, one on each respective radial edge, said slots aligned with one another as part of said slot ring.

16. The parachute canopy as set forth in claim 15, wherein said radial slots follow a cloth weave of said gore so as to have a truncated rectangular shape.

17. The parachute canopy as set forth in claim 15, wherein said radial slots are parallel to said radials so as to have a rectangular shape.

18. The parachute canopy as set forth in claim 15, wherein each gore includes a second pair of radial slots circumferentially aligned with one another and positioned between said shoulder portion slot ring and said pressure vent ring so as to form a second radial slot ring spaced from and concentric with said shoulder portion slot ring.

19. The parachute canopy as set forth in claim 18, wherein the slots in said shoulder portion slot ring follow a cloth weave of said gore so as to have a truncated rectangular shape.

20. The parachute canopy as set forth in claim 18, wherein the slots in said second radial slot ring are parallel to said radials so as to have a rectangular shape.

21. The parachute canopy as set forth in claim 14, wherein said slots are covered with a mesh panel.

22. The parachute canopy as set forth in claim 21, wherein said mesh panel is shaped to correspond to a non-mesh-covered inflated radial slot shape.
